(19) United States
(12) Patent Application Publication
(10) Pub. No.: US 2012/0168289 A1
(43) Pub. Date: Jul. 5, 2012

(54) Handgrip For Portable Working Tool And Portable Working Tool Equipped With The Same

(75) Inventors: Takafumi Ito, Ibaraki (JP); Shingo Kosugi, Ibaraki (JP); Hirohide Kawada, Ibaraki (JP)

(73) Assignee: Hitachi Koki Co., Ltd., Tokyo (JP)

(21) Appl. No.: 13/338,528

(22) Filed: Dec. 28, 2011

(30) Foreign Application Priority Data
Dec. 29, 2010 (JP) 2010-294443

(51) Int. Cl. H01H 9/06

(52) U.S. Cl. 200/61.85

(57) ABSTRACT

The present invention provides a grip provided around a hollow handle pipe of a portable working tool. The grip includes: a switch unit configured to control operation of the portable working tool; a grip portion for enabling an operator to hold the portable working tool, the grip portion extending in an extending direction and having one end and another end opposite to the one end; a pipe insertion portion formed at the one end of the grip portion and formed with a pipe insertion hole from which the handle pipe is inserted; and a switch mounting portion formed at the another end of the grip portion and formed with a switch mounting hole in which the switch unit is mounted, the grip portion, the pipe insertion portion and the switch mounting portion being integrally formed of an elastic material.

### CROSS REFERENCE TO RELATED APPLICATION

This application claims priority from Japanese Patent Application No. 2010-294443 filed Dec. 29, 2010. The entire content of this priority application is incorporated herein by reference.

### TECHNICAL FIELD

The present invention relates to a handgrip for holding a portable working tool, such as a brushcutter.

### BACKGROUND

One type of conventional handgrip for a portable working tool well-known in the art is configured of a rigid resin member (a plastic, for example) and an elastic material covering the resin member (elastomer, for example) in order to improve operator's sense of gripping at the time of performing cutting work as well as to suppress transmission of vibration during the cutting work. Japanese Patent Application Publication No. H11-253025 discloses one of such handgrip in which either a plastic assembly alone or a plastic assembly coated with an elastomer material constitutes the handgrip to which a switch box is fixed by screwing.

### SUMMARY

However, in the above-identified handgrip, a plurality of plastic components needs to be screwed together to form the plastic assembly, and the elastomer material further needs to be applied to the plastic assembly. Therefore, an increased number of components are required, and a manufacturing process inevitably becomes complex.

In view of the foregoing, it is an object of the present invention to provide a handgrip for a portable working tool capable of being manufactured with a smaller number of components, with reduced production costs, and in a simpler manufacturing process.

In order to attain the above and other objects, the present invention provides a grip provided around a hollow handle pipe of a portable working tool. The grip includes: a switch unit configured to control operation of the portable working tool; a grip portion for enabling an operator to hold the portable working tool; a pipe insertion portion; and a switch mounting portion. The grip portion extends in an extending direction and has one end and another end opposite to the one end. The pipe insertion portion is formed at the one end of the grip portion and is formed with a pipe insertion hole from which the handle pipe is inserted. The switch mounting portion is formed at the another end of the grip portion and is formed with a switch mounting hole in which the switch unit is mounted. The grip portion, the pipe insertion portion and the switch mounting portion is integrally formed of an elastic material.

Preferably, the grip portion is formed with a through-hole extending in the extending direction, the pipe insertion hole and the switch mounting hole being in fluid communication with each other via the through-hole, the handle pipe being inserted into the through-hole from the pipe insertion hole.

Preferably, the switch mounting hole has a bottom surface with which the switch unit is in abutment when the switch unit is mounted, and the through-hole has an end surface with which the handle pipe is in abutment when the handle pipe is inserted, the bottom surface and the end surface are positioned adjacent to each other in the extending direction.

Preferably, the switch unit includes terminals connected to a drive source for driving the portable working tool, the terminals being positioned within an inner space of the hollow handle pipe for positioning the switch unit relative to the grip portion.

Preferably, the switch mounting hole has an inner peripheral surface on which a recessed portion is formed, and the switch unit has a projection configured to be engaged with the recessed portion when the switch unit has been mounted in the switch mounting hole.

Preferably, the pipe insertion hole has a first axis extending in the extending direction and the switch mounting hole has a second axis extending in a direction intersecting the first axis.

Preferably, the second axis is slanted relative to the first axis by an angle of 10 degrees.

Preferably, the grip portion includes a first portion and a second portion, the first portion being brought into contact with an operator's palm and the second portion being brought into contact with operator's fingers when the operator grips the grip portion, and the second axis being slanted relative to the first axis toward the first portion of the grip portion.

Preferably, the switch mounting portion further includes a first protruding portion and the pipe insertion portion further includes a second protruding portion, the second portion being positioned between the first and second protruding portions in the extending direction, the first and second protruding portions gradually protruding outward in a direction perpendicular to the extending direction.

Preferably, the switch mounting portion further includes a surrounding portion disposed around the switch mounting hole, the surrounding portion partially surrounding the switch unit and protrudes outward than the switch unit mounted in the switch mounting hole in the extending direction.

According to another aspect, the present invention provides a portable working tool. The working tool includes a drive source for driving the portable working tool, a hollow handle pipe and a grip provided around the hollow handle pipe. The grip includes: a switch unit configured to control driving of the drive source; a grip portion for enabling an operator to hold the portable working tool; a pipe insertion portion and a switch mounting portion. The grip portion extends in an extending direction and has one end and another end opposite to the one end. The pipe insertion portion is formed at the one end of the grip portion and is formed with a pipe insertion hole from which the handle pipe is inserted. The switch mounting portion is formed at the another end of the grip portion and is formed with a switch mounting hole in which the switch unit is mounted. The grip portion, the pipe insertion portion and the switch mounting portion are integrally formed of an elastic material.

With this configuration, since the grip portion, the pipe insertion portion and the switch mounting portion are all integrally formed of an elastic material, the grip can be manufactured with a reduced number of parts, with lower production costs, and in a simpler manufacturing process. Further, the grip according to the embodiment is configured solely of an elastic material (elastomer), without necessitating many complementary parts. Therefore, the operator does not feel a sense of discomfort at the time of gripping since there is no parting face line of the complementary parts nor any screw seat, and cutting work can be done with improved workability.

### BRIEF DESCRIPTION OF THE DRAWINGS

In the drawings:

FIG. 1 is an external view of a brushcutter equipped with a handgrip according to an embodiment of the invention;

FIG. 2 is a vertical cross-sectional view of the handgrip according to the embodiment of the invention;

FIG. 3 is an exploded cross-sectional view of the handgrip of FIG. 2;

FIG. 4 is a top view of the handgrip according to the embodiment of the invention;

FIG. 5 is a side view of the handgrip according to the embodiment of the invention; and

FIG. 6 is a view showing a state where the brushcutter of FIG. 1 is placed upside down.

### DETAILED DESCRIPTION

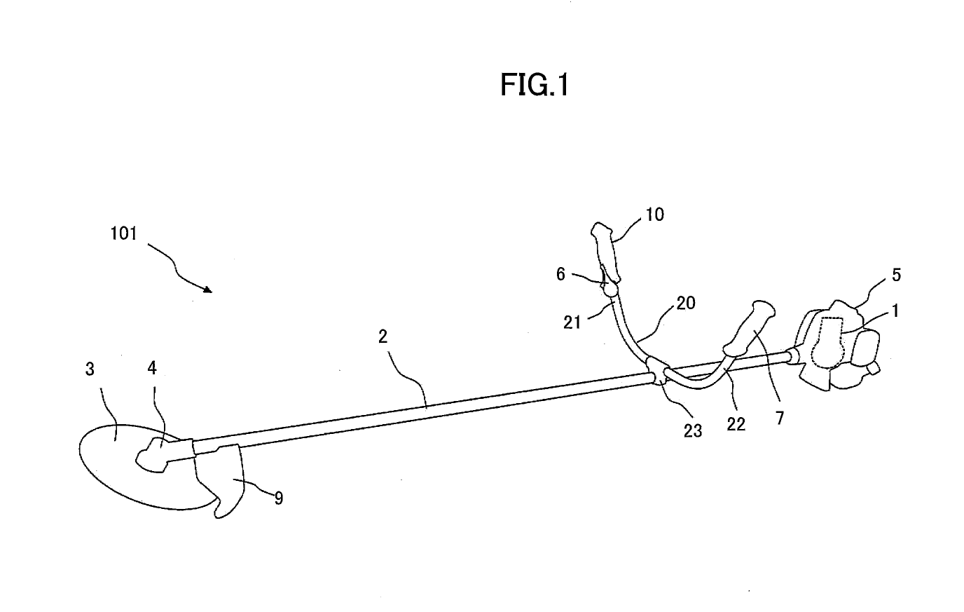

First, a general construction of a brushcutter 101 as an example of a portable working tool according to an embodiment of the invention will be described while referring to FIG. 1.

The brushcutter 101 mainly includes a pipe section 2, a rotary cutting blade 3, a driving section 5 and a handle pipe 20, as shown in FIG. 1. The pipe section 2 is a hollow pipe, having one end on which the rotary cutting blade 3 is rotatably mounted via a gear case 4 and another end on which the driving section 5 is mounted. The driving section 5 accommodates therein an engine 1 as an example of the claimed drive source for driving the rotary cutting blade 3.

The handle pipe 20 is a U-shaped hollow pipe, and is made from an aluminum alloy. The handle pipe 20 is assembled to the pipe section 2 via an attachment section 23 at a position adjacent to a longitudinal center of the pipe section 2 but closer to the driving section 5 than to the rotary cutting blade 3. When viewed from the driving section 5, the handle pipe 20 has a right end portion 21 on which a handgrip 10 is provided and a left end portion 22 on which a handgrip 7 is mounted. With this configuration, an operator can firmly grip the handgrips 7, 10 with his hands when holding the brushcutter 101.

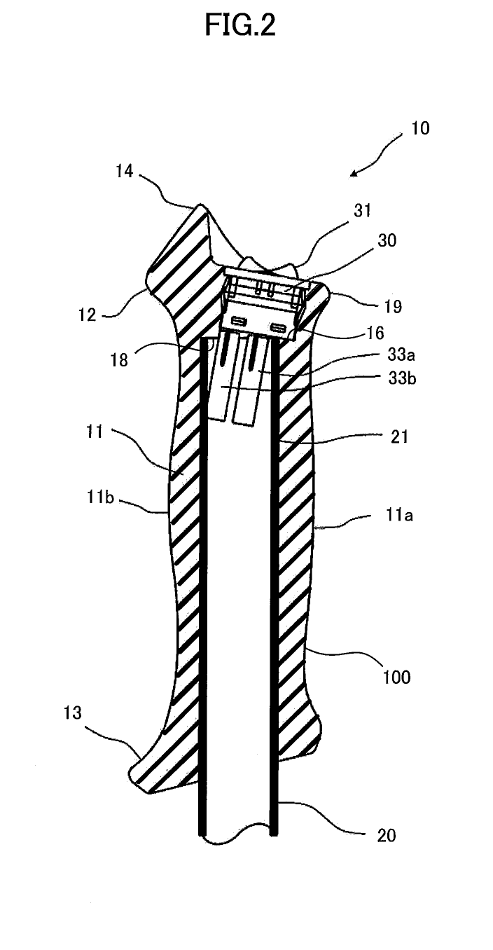

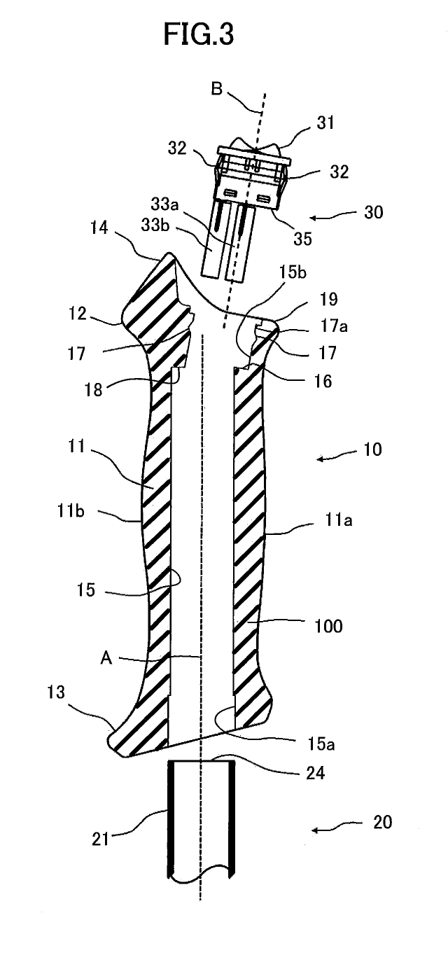

On the right end portion 21 of the handle pipe 20, a throttle lever 6 is disposed below the handgrip 10 for enabling the operator to adjust a rotational speed of the engine 1. The throttle lever 6 is shown in FIG. 1, but omitted in FIGS. 2 and 3. Further, as will be described later, the handgrip 10 includes a switch 31 (see FIGS. 2 and 3) for allowing the operator to stop/start the engine 1. The operator can operate the throttle lever 6 and the switch 31, while gripping the handgrips 7, 10 to hold the brushcutter 101.

Next, a detailed configuration of the handgrip 10 according to the embodiment of the present invention will be described with reference to FIGS. 2 through 5.

The handgrip 10 is configured of a grip member 100 and a switch unit 30 including the switch 31, as shown in FIGS. 2 and 3.

The grip member 100 is integrally made from an elastic material, such as rubber and elastomer. The grip member 100 has a substantially cylindrical shape. Hereinafter, a direction in which the grip member 100 extends will be referred to as an extending direction. The grip member 100 has a longitudinal central portion 11 protruding radially outward for facilitating operator's gripping the handgrip 10, as shown in FIGS. 2, 3 and 5. This longitudinal central portion 11 serves as a grip portion 11, and is configured of a palm-side grip portion 11a and a finger-side grip portion 11b. In FIG. 2, when the operator grips the handgrip 10, the operator's palm is in contact with the palm-side grip portion 11a, while the operator's fingers other than his thumb are in contact with the finger-side grip portion 11b. The grip portion 11 functions as the claimed grip portion, and the palm-side grip portion 11a and the finger-side grip portion 11b function as the claimed first portion and the claimed second portion respectively.

The grip portion 11 is formed with a cylindrical-shaped through-hole 15 penetrating through the grip portion 11 in the extending direction. The grip portion 11 and the through-hole 15 share an axis A in the extending direction, as show in FIG. 3.

The grip member 100 has an upper end portion on which a switch installation hole 15b is formed and a lower end portion on which a handle pipe insertion hole 15a is formed in the extending direction, as shown in FIG. 3. The switch installation hole 15b is adapted to accommodate the switch unit 30 therein, and the handle pipe insertion hole 15a is adapted to receive therein the handle pipe 20 (more precisely, the right end portion 21). The upper end portion and the lower end portion of the grip member 100 function as the claimed switch mounting portion and the pipe insertion portion respectively.

The handle pipe insertion hole 15a and the switch installation hole 15b are respectively in fluid communication with the through-hole 15. The handle pipe insertion hole 15a is concentrically arranged with the through-hole 15 (the handle pipe insertion hole 15a and the through-hole 15 share the axis A). The switch installation hole 15b has an axis B that is slanted relative to the axis A by an angle of about 10 degrees such that the switch 31, which is mounted in the switch installation hole 15b, is oriented diagonally downward toward the palm-side grip portion 11a, as shown in FIG. 3.

The switch unit 30 is inserted in and fitted with the switch installation hole 15b. The switch unit 30 is a well-known switch provided with the switch 31 (a seesaw switch) and terminals 33a, 33b. When the operator manipulates the switch 31, wirings (not shown) extending from the terminals 33a, 33b are configured to be connected to/disconnected from an ignition coil (not shown) of the engine 1 such that power supply to the ignition coil (ignition plug) is either shut down or realized.

As shown in FIG. 3, the switch unit 30 has a substantially rectangular-shaped cross-section. The switch unit 30 has a pair of side surfaces from each of which a projecting portion 32 projects outward, and a bottom surface 35. The switch installation hole 15b has an inner circumferential wall 17a and a bottom wall 16. The inner circumferential wall 17a is formed with a pair of recessed portions 17 each at a position corresponding to each projecting portion 32 of the switch unit 30. The projecting portion 32 functions as the claimed projection, and the recessed portion 17 functions as the claimed recessed portion. The bottom wall 16 first extends from the inner circumferential wall 17a toward the axis A, and is then connected to an inner circumferential surface of the through-hole 15. As the switch unit 30 is pushed into the switch installation hole 15b, the switch unit 30 elastically deforms the inner circumferential wall 17a and is further moved downward to reach a position where each projecting portion 32 is engaged with each recessed portion 17. At this time, the bottom surface 35 of the switch unit 30 is in abutment with the bottom wall 16 of the switch installation hole 15b. In this way, the switch unit 30 is fixed to the grip member 100. The bottom wall 16 functions as the claimed bottom surface.

The through-hole 15 is formed to have an inner diameter substantially equal to or slightly smaller than an outer diameter of the handle pipe 20. The handle pipe insertion hole 15a has an inner diameter slightly greater than that of the through-hole 15 for facilitating initial insertion of the handle pipe 20, as shown in FIG. 3. The through-hole 15 has an upper end wall 18 that is connected to the switch installation hole 15b, as shown in FIG. 3. Upon assembling of the grip member 100 to the handle pipe 20, the right end portion 21 of the handle pipe 20 is inserted into the through-hole 15 from the handle pipe insertion hole 15a. When the upper end wall 18 of the through-hole 15 is brought into abutment with an open end 24 of the right end portion 21, relative position between the handle pipe 20 and the grip member 100 is fixed. At this time, the grip member 100 is force-fitted with the right end portion 21 due to the elastic deformation of the grip member 100. The upper end wall 18 functions as the claimed end surface.

As shown in FIG. 2, the bottom wall 16 of the switch installation hole 15b and the upper end wall 18 of the through-hole 15 are positioned adjacent to each other in the extending direction. In other words, when mounting of the handgrip 10 on the handle pipe 20 is completed, the handle pipe 20 is positioned to contact with the upper end wall 18 of the through-hole 15 and the bottom surface 35 of the switch unit 30. With this configuration, rigidity of the handgrip 10 can be enhanced, and the switch unit 30 can be stably held to the grip member 100 and the handle pipe 20. The operator can thus enjoy enhanced operability of the switch 31. Further, the terminals 33a, 33b of the switch unit 30 are inserted, through the open end 24, into an inner space within the hollow right end portion 21 and accommodated therein such that the switch unit 30 can be positioned at a given position relative to the grip member 100 and the handle pipe 20. With this configuration, since the inner space within the handle pipe 20 can be effectively utilized for stably supporting the switch unit 30, a thickness of the handgrip 10 in a radial direction of the handgrip 10 can be reduced and a length in the extending direction can also be reduced. Further, since the inner diameter of the through-hole 15 is substantially identical to or slightly smaller than the outer diameter of the handle pipe 20, simple force-fitting of the grip member 100 with the handle pipe 20 can securely prevent the grip member 100 from being taken off from the handle pipe 20.

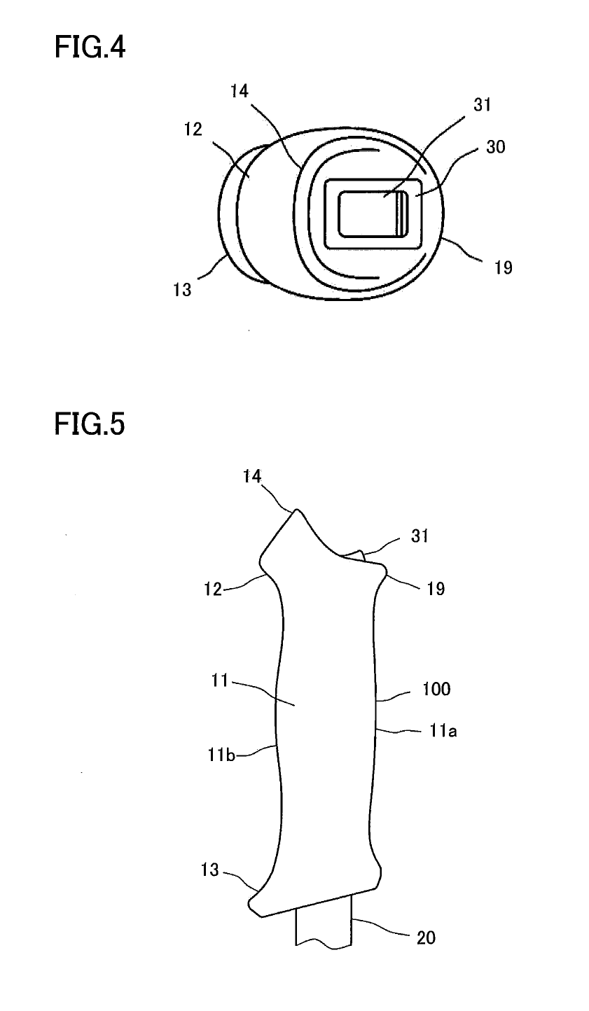

As shown in FIGS. 4 and 5, the upper end portion of the grip member 100 serving as the claimed switch mounting portion is further formed with a protruding portion 12 above the finger-side grip portion 11b, and the lower end portion of the grip member 100 serving as the claimed pipe insertion portion is further formed with another protruding portion 13 below the finger-side grip portion 11b. The protruding portion 12 gently projects radially outward and upward, while the protruding portion 13 gently projects radially outward and downward. With this configuration, the operator can stably hold the grip member 100. For holding the grip member 100, the operator places his palm at the palm-side grip portion 11a, and wraps and grasps the finger-side grip portion 11b with his fingers other than his thumb. The operator can thus stably hold the grip portion 11 of the grip member 100, while operating the switch 31 with his thumb. Further, the gentle slopes provided by the protruding portions 12, 13 ensure that the operator can have an enough range of movement for his fingers and the operability of the throttle lever 6 can be enhanced without disturbing the cutting work. The protruding portions 12, 13 respectively correspond to the claimed first and second protruding portions.

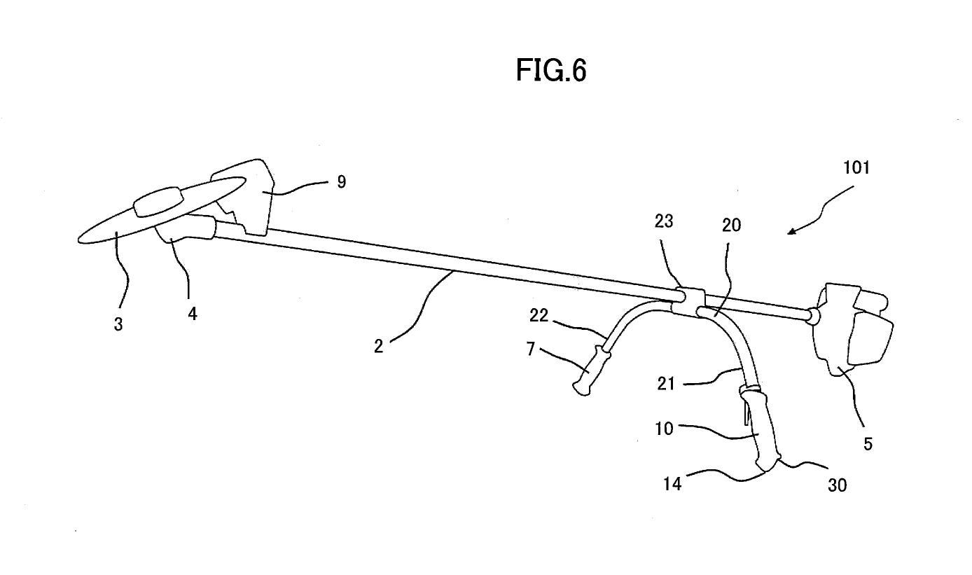

The upper end portion of the grip member 100 serving as the claimed switch mounting portion further includes a surrounding portion 14 and a projecting portion 19. The surrounding portion 14 is positioned at the finger-side grip portion 11b side relative to the switch installation hole 15b, while the projecting portion 19 is positioned at the palm-side grip portion 11a side relative to the switch installation hole 15b. More specifically, as shown in FIGS. 4 and 5, the surrounding portion 14 is substantially C-shaped and projects upward from a peripheral portion of the switch installation hole 15b at the finger-side grip portion 11b side to partially surround the switch installation hole 15b. The projecting portion 19 projects radially outward from the peripheral portion of the switch installation hole 15b at the palm-side grip portion 11a side. The surrounding portion 14 and the projecting portion 19 thus provide a rib-like wall defining a recess. When the switch unit 30 has been completely mounted in the switch installation hole 15b, the switch 31 is partially surrounded by the rib-like wall or positioned within the recess. This construction can prevent the switch 31 from being accidentally turned on and off when the handgrip 10 is unexpectedly hit against something. In other words, providing the surrounding portion 14 adjacent to the switch 31 can prevent the switch 31 from being operated carelessly. Also, the surrounding portion 14 can protect the switch unit 30 from being damaged when the brushcutter 101 is placed on the ground in an upside-down state for replacement of the rotary cutting blade 3, as shown in FIG. 6, since the surrounding portion 14 can be brought into contact with the ground earlier than the switch 31.

As described above, according to the brushcutter 101 of the present embodiment, the grip member 100 of the handgrip 10 is solely and integrally made from an elastomer or a rubber. Compared to a conventional handgrip in which a plurality of plastic parts needs to be screwed together and coated by an elastic material, no screws are necessary for manufacturing the grip member 100. As a result, a reduced number of complementary parts and a smaller number of molded products are required, leading to a reduction in production costs. Further, this construction can also serve to mitigate operator's sense of discomfort resulting from operator's contact with screws, parting face lines (matching surfaces) of parts.

Further, the switch unit 30 can be easily fitted in the switch installation hole 15b of the grip member 100 by simply inserting and pushing the switch unit 30 into the switch installation hole 15b. And the switch unit 30 can be securely fixed to the switch installation hole 15b due to the engagement between the projecting portion 32 of switch unit 30 and the recessed portion 17 of the switch installation hole 15b. Therefore, improved productivity of the handgrip 10 can be achieved.

Further, according to the handgrip 10 of the embodiment, even though the switch unit 30 is directly mounted in the elastic grip member 100, the handle pipe 20 inserted into the grip member 100 is utilized for stably positioning the switch unit 30. That is, the inner space within the handle pipe 20 is used for stably supporting the switch unit 30 within the grip member 100. Therefore, the switch unit 30 can be prevented from sinking into and being embedded within the elastic grip member 100 even when the operator pushes the switch 31 to operate the same. User's operability of the handgrip 10 is thus enhanced. Further, since the axis B of the switch unit 30 is arranged to be slanted relative to the axis A of the grip member 100, the operator can smoothly operate the switch 31 while holding the grip member 100, thereby improving operability of the handgrip 10.

Further, due to the provision of the gently-sloped protruding portions 12, 13 interposing the finger-side grip portion 11b in the extending direction, the operator can comfortably grip the handgrip 10 while enjoying the enlarged range of movement of his fingers. With this configuration, enhanced operability can be obtained.

Further, according to the handgrip 10 of the embodiment, the switch unit 30 is partially surrounded by the surrounding portion 14 protruding outward than the switch unit 30 in the extending direction. With this configuration, regardless of what kind of posture the brushcutter 101 may take, the switch 31 cannot be pressed carelessly and easily. For example, when the rotary cutting blade 3 is being replaced, the switch 31 can be prevented from being in contact with the ground and suppressed from being operated at an unexpected timing. Further, since the switch unit 30 is arranged to be slanted relative to the axis A of the grip member 100 such that the switch 31 is oriented toward the operator, the operator can operate the switch 31 smoothly without being disturbed by the existence of the surrounding portion 14.

While the invention has been described in detail with reference to the embodiments thereof, it would be apparent to those skilled in the art that various changes and modifications may be made therein without departing from the scope of the invention.

For example, in the embodiment, the present invention is applied to the brushcutter 1 provided with the pipe section 2, the driving section 5 and the rotary cutting blade 3. However, the present invention may also be applicable to a back pack brushcutter, and a power tool other than the brushcutter equipped with handgrips on a pipe section, such as a pole saw and a cultivator.

What is claimed is:

1. A grip provided around a hollow handle pipe of a portable working tool, comprising:
a switch unit configured to control operation of the portable working tool;
a grip portion for enabling an operator to hold the portable working tool, the grip portion extending in an extending direction and having one end and another end opposite to the one end;
a pipe insertion portion formed at the one end of the grip portion and formed with a pipe insertion hole from which the handle pipe is inserted; and
a switch mounting portion formed at the another end of the grip portion and formed with a switch mounting hole in which the switch unit is mounted, the grip portion, the pipe insertion portion and the switch mounting portion being integrally formed of an elastic material.

2. The grip according to claim 1, wherein the grip portion is formed with a through-hole extending in the extending direction, the pipe insertion hole and the switch mounting hole being in fluid communication with each other via the through-hole, the handle pipe being inserted into the through-hole from the pipe insertion hole.

3. The grip according to claim 2, wherein the switch mounting hole has a bottom surface with which the switch unit is in abutment when the switch unit is mounted, and the through-hole has an end surface with which the handle pipe is in abutment when the handle pipe is inserted, the bottom surface and the end surface being positioned adjacent to each other in the extending direction.

4. The grip according to claim 3, wherein the switch unit includes terminals connected to a drive source for driving the portable working tool, the terminals being positioned within an inner space of the hollow handle pipe for positioning the switch unit relative to the grip portion.

5. The grip according to claim 1, wherein the switch mounting hole has an inner peripheral surface on which a recessed portion is formed, and
wherein the switch unit has a projection configured to be engaged with the recessed portion when the switch unit has been mounted in the switch mounting hole.

6. The grip according to claim 1, wherein the pipe insertion hole has a first axis extending in the extending direction and the switch mounting hole has a second axis extending in a direction intersecting the first axis.

7. The grip according to claim 6, wherein the second axis is slanted relative to the first axis by an angle of 10 degrees.

8. The grip according to claim 6, wherein the grip portion includes a first portion and a second portion, the first portion being brought into contact with an operator's palm and the second portion being brought into contact with operator's fingers when the operator grips the grip portion, and the second axis being slanted relative to the first axis toward the first portion of the grip portion.

9. The grip according to claim 8, wherein the switch mounting portion further comprises a first protruding portion and the pipe insertion portion further comprises a second protruding portion, the second portion being positioned between the first and second protruding portions in the extending direction, the first and second protruding portions gradually protruding outward in a direction perpendicular to the extending direction.

10. The grip according to claim 1, wherein the switch mounting portion further comprises a surrounding portion disposed around the switch mounting hole, the surrounding portion partially surrounding the switch unit and protrudes outward than the switch unit mounted in the switch mounting hole in the extending direction.

11. A portable working tool comprising:
a drive source for driving the portable working tool;
a hollow handle pipe; and
a grip provided around the hollow handle pipe, the grip including:
a switch unit configured to control driving of the drive source;
a grip portion for enabling an operator to hold the portable working tool, the grip portion extending in an extending direction and having one end and another end opposite to the one end;
a pipe insertion portion formed at the one end of the grip portion and formed with a pipe insertion hole from which the handle pipe is inserted; and
a switch mounting portion formed at the another end of the grip portion and formed with a switch mounting hole in which the switch unit is mounted, the grip portion, the pipe insertion portion and the switch mounting portion being integrally formed of an elastic material.
